(19) United States
(12) Patent Application Publication
(10) Pub. No.: US 2014/0287514 A1
(43) Pub. Date: Sep. 25, 2014

(54) LUMINESCENT MICROPOROUS MATERIAL FOR DETECTION AND DISCRIMINATION OF LOW-LEVELS OF COMMON GASES AND VAPORS

(71) Applicant: Board of Regents, The University of Texas System, Austin, TX (US)

(72) Inventors: Simon M. Humphrey, Austin, TX (US); Bradley J. Holliday, Austin, TX (US)

(21) Appl. No.: 14/215,731

(22) Filed: Mar. 17, 2014

Related U.S. Application Data
(60) Provisional application No. 61/803,231, filed on Mar. 19, 2013.

(51) Int. Cl. C07F 9/53; G01N 31/22

(52) U.S. Cl. CPC C07F 9/5345; G01N 31/223
USPC 436/39; 422/91; 436/167; 436/133; 436/131; 436/132; 436/116; 436/111; 436/144; 436/140; 436/141; 436/139; 436/136; 436/120; 534/15

(57) ABSTRACT

The present invention includes a sensing device and method detecting the presence of a chemical analyte, comprising: a surface; a continuous or discontinuous terbium(III)-triphenylphosphine oxide coordination polymer layer deposited on the surface, wherein the polymer layer is porous; and a luminescence detector, wherein one or more analytes that interact with the polymer layer luminesce at distinct wavelengths unique to each analyte.

### CROSS-REFERENCE TO RELATED APPLICATIONS

This application claims priority to U.S. Provisional Patent Application Ser. No. 61/803,231, filed Mar. 19, 2013.

### TECHNICAL FIELD OF THE INVENTION

The present invention relates in general to the field of gas detection, and more particularly, to a luminescent microporous material for detection and discrimination of low-levels of common gases and vapors.

### STATEMENT OF FEDERALLY FUNDED RESEARCH

None.

### BACKGROUND OF THE INVENTION

Without limiting the scope of the invention, its background is described in connection with porous coordination polymers.

For example, U.S. Pat. No. 8,367,419, issued to Li, et al., is entitled, “Compositions and methods for detection of explosives.” The patent is directed to polymeric coordination compounds capable of forming three-dimensional microporous metal organic frameworks (MMOFs) that are useful for detection of explosive compounds. The polymeric coordination compounds are said to comprise a repeating unit comprising a transition metal coordinated to at least one binding member of a bidentate binding site on each of two polyfunctional ligands and one binding site of a bis-pyridine exodentate bridging ligand. Methods of preparing, using, and sensors or sensor arrays, that use the polymeric coordination compounds for detection of explosive compounds are said to be disclosed.

Another example is U.S. Pat. No. 8,222,179, issued to Matzger, et al., entitled, “Porous coordination copolymers and methods for their production.” This patent is directed to a coordination polymer that includes metal atoms or metal clusters linked together with organic linking ligands. Each linking ligand includes a residue of a negatively charged polydentate ligand. The multidentate ligands include a first linking ligand having first hydrocarbon backbone and a second ligand having a second hydrocarbon backbone, wherein the first hydrocarbon backbone is different from the second hydrocarbon backbone.

U.S. Pat. No. 8,065,904, issued to Allendorf, et al., is entitled “Method and apparatus for detecting an analyte.” The patent is directed to the use of coordination polymers as coatings on microcantilevers for the detection of chemical analytes. The coordination polymers are said to exhibit changes in unit cell parameters upon adsorption of analytes, which induce a stress in a static microcantilever upon which a coordination polymer layer is deposited. Fabrication methods for depositing coordination polymer layers on surfaces are also said to be taught.

Another polymer is taught in United States Patent Application Publication No. 2010/0273642, filed by Chang, directed to a preparation of surface functionalized porous organic-inorganic hybrid materials or mesoporous materials with coordinatively unsaturated metal sites and catalytic applications. The application is said to teach a method of surface-functionalizing a porous organic-inorganic hybrid material or a organic-inorganic mesoporous material, in which organic substances, inorganic substances, ionic liquids and organic-inorganic hybrid substances that are selectively functionalized on the coordinatively unsaturated metal sites of a porous organic-inorganic hybrid material or organic-inorganic mesoporous material. The porous organic-inorganic hybrid materials are said to be used for adsorbents, gas storage devices, sensors, membranes, functional thin films, catalysts, catalytic supports, and the like, and the applications of the surface-functionalized porous organic-inorganic hybrid material prepared using the method to catalytic reactions.

Another such polymer is taught in United States Patent Application Publication No. 2009/0131703, filed by Jhung, et al., for a Preparation Method of Porous Organic Inorganic Hybrid Materials. Briefly, these applicants present a synthesis method of porous hybrid inorganic-organic materials that can be applied to adsorbents, gas storages, sensors, membranes, functional thin films, catalysts, catalyst supports, encapsulating guest molecules and separation of molecules by the pore structures. Synthesis method of nanocrystalline porous hybrid inorganic-organic materials are said to be taught.

### SUMMARY OF THE INVENTION

The present invention is directed to compositions, methods and devices that include a composition comprising a terbium(III)-triphenylphosphine oxide coordinated polymer. In one aspect, the polymer is formed as a layer on a substrate. In one embodiment, the present invention includes a method of making a composition comprising: dissolving a tris(p-carboxylato)triphenylphosphine (P(C₆H₄-pCO₂Li)₃ in an aqueous solution in the presence of H₂O₂ under conditions to form a tris(p-carboxylic)triphenylphosphine oxide (P(═O)(C₆H₄-p-CO₂H)₃), precipitated by acidification and isolated by vacuum filtration; mixing the tris(p-carboxylic)triphenylphosphine oxide (P(═O)(C₆H₄-p-CO₂H)₃) in the presence of terbium nitrate, dimethylformamide (DMF), tetrahydrofuran (THF), H₂O, and acid at 85° C.; and isolating the Tb(tris(p-carboxylic)triphenylphosphine oxide)(OH2)].2DMF.H2O from the solvents under vacuum. In one aspect, the acid is HCl. In another aspect, the H₂O₂ is 30%.

In another embodiment, the present invention includes a sensor comprising a terbium(III)-triphenylphosphine oxide coordination polymer surface deposited on a surface, wherein an analyte that interacts with the polymer layer luminesces in a distinct wavelength unique to each analyte. In yet another aspect, the present invention includes a sensing device for detecting the presence of a chemical analyte, comprising: a surface; a continuous or discontinuous terbium(III)-triphenylphosphine oxide coordination polymer layer deposited on the surface, wherein the polymer layer is porous; and a luminescence detector, wherein one or more analytes that interact with the polymer layer luminesce at distinct wavelengths unique to each analyte. In one aspect, the terbium(III)-triphenylphosphine oxide coordination polymer layer comprises a metal organic framework. In another aspect, the terbium(III)-triphenylphosphine oxide coordination polymer layer comprises any crystalline material comprised of organic and/or inorganic portions in a porous structure. In another aspect, the analyte binding to the polymer layer is reversible and the sensor can be reused. In another aspect, the sensor can be hydrated and dehydrated. In another aspect, the polymer layer is formed by a process selected from at least one of chemical vapor deposition, physical vapor deposition, atomic layer deposition, and electrolytic deposition. In another aspect, the sensor further comprises a reference sensing device for providing a baseline reference, wherein the reference sensing device comprises a second surface without a terbium(III)-triphenylphosphine oxide coordination polymer layer. In another aspect, the sensor further comprises a plurality of sensing devices. In another aspect, the sensing device senses molecular species selected at least one of water vapor, carbon dioxide, hydrogen, toluene, cyclohexane, n-hexane, carbon monoxide, carbon dioxide, benzene, methanol, ethanol, nitric oxide, nitrous oxide, oxygen, dimethylsulfoxide, and amines.

In another embodiment, the present invention includes a method for detecting the presence of a chemical species, comprising the steps of: providing a surface onto which a continuous or discontinuous terbium(III)-triphenylphosphine oxide coordination polymer layer deposited on the surface, wherein the polymer layer is porous; contacting the polymer layer with one or more analytes; and detecting luminescence at the polymer layer, wherein one or more analytes that interact with the polymer layer luminesce unique to each analyte. In one aspect, the terbium(III)-triphenylphosphine oxide coordination polymer layer comprises a metal organic framework. In another aspect, the terbium(III)-triphenylphosphine oxide coordination polymer layer comprises any crystalline material comprised of organic and/or inorganic portions in a porous structure. In another aspect, the analyte binding to the polymer layer is reversible and the sensor can be reused by applying a vacuum between exposure of the polymer layer to an analyte or analytes. In another aspect, the polymer layer is formed by a process selected from the list of processes selected from at least one of mechanical deposition, chemical vapor deposition, physical vapor deposition, atomic layer deposition, and electrolytic deposition. In another aspect, the method further comprises a reference sensing device for providing a baseline reference, wherein the reference sensing device comprises a second surface without a terbium(III)-triphenylphosphine oxide coordination polymer layer. In another aspect, the method further comprises a plurality of sensing devices. In another aspect, the sensing device senses molecular species selected from the list consisting of water vapor, carbon dioxide, methanol, ethanol, carbon monoxide, nitric oxide, nitrous oxide, organic amines, and organic compounds containing NO₂ groups. In another aspect, the response of the sensor is controlled by the hydration state of the terbium(III)-triphenylphosphine oxide coordination polymer layer. In another aspect, the method further comprises a plurality of sensing devices. In another aspect, the sensing device senses molecular species selected at least one of water vapor, carbon dioxide, hydrogen, toluene, cyclohexane, n-hexane, carbon monoxide, carbon dioxide, benzene, methanol, ethanol, nitric oxide, nitrous oxide, oxygen, dimethylsulfoxide, and amines. In another aspect, the luminescence is detected using a spectrophotometer.

### BRIEF DESCRIPTION OF THE DRAWINGS

For a more complete understanding of the features and advantages of the present invention, reference is now made to the detailed description of the invention along with the accompanying figures and in which:

FIG. 1A is an overlay of structural and space-filling views of PCM-15 along the b-axis; green dashed line shows largest corner-to-corner accessible distance (14.2 Å); Tb=cyan; P=magenta; OH2=yellow. FIG. 1B. Left: expanded view of the asymmetric unit in as-synthesized PCM-15; right: after removal of the single OH₂ ligand from the Tb(III) coordination sphere.

FIG. 2: TGA analysis of as synthesised PCM-15 under He carrier flow.

FIG. 3: TGA analysis of preactivated (190° C. and 1×10⁻¹⁰ bar for 6 h) PCM-15 under He carrier flow.

FIG. 4: TGA analysis of preactivated (300° C. and 1×10⁻¹⁰ bar for 6 h) PCM-15 under He carrier flow.

FIG. 5: TGA analysis of preactivated PCM-15 exposed to EtOH vapour under He carrier flow.

FIG. 6. PXRD patterns of as-synthesized PCM-15 (black), the activated form (red), and after exposure to three molecular guest adsorbates.

FIG. 7. PXRD data showing retention of crystallinity upon desolvation and subsequent rehydration of the activated PCM-15 solid.

FIG. 8. Plot of the measured luminescence intensities and associated errors for activated PCM-15 in the presence of atmospheric pressures of various molecular adsorbates. All data is normalized versus the activated luminescence intensity.

FIG. 9. Summary of the measured luminescence intensities and associated errors for activated PCM-15 in the presence of atmospheric pressures of various molecular adsorbates. All data is normalized versus the activated luminescence intensity.

FIG. 10. Adsorption-desorption isotherms for a range of organic vapors in PCM-15.

FIG. 11. Relative luminescence quenching observed as a function of NH3 concentration in an H₂-saturated sample of PCM-15; inset: calibration curve showing linear response.

FIG. 12. Competition studies between NH3 and H2 in PCM-15: (a) activation→H2→NH3; (b) activation→NH3→H2.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not limit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not limit the scope of the invention, except as outlined in the claims.

The present invention includes a terbium(III)-triphenylphosphine oxide coordination polymer (PCM-15), which is a robust and recyclable sensor for the effective discrimination of a wide range of small molecules. Sensing can achieved by, e.g., direct measurement of the relative luminescence quenching of Tb(III) ions by molecular species that penetrate the material. PCM-15 has an open porous structure and contains isolated, monohydrated Tb(III) centers. The coordinated water can be easily and completely removed under vacuum at 423 K; meanwhile, the framework rigidity resists changes to the unsaturated coordination environment around each Tb(III). The dehydrated material shows a two-fold increase in total luminescence intensity. Subsequent exposure of the material to a range of gases and small molecule vapors results in characteristic modulation of the total luminescence intensity via quenching. This process is completely reversible and the same crystalline sample can be regenerated many times. To demonstrate the potential practical application of this material, a study involving trace amounts of NH₃ in H₂ gas indicates that PCM-15 may be effectively utilized to sense trace impurities.

Porous coordination polymer (PCP) materials continue to attract wide-spread attention, particularly for small molecule storage and separation.¹ PCPs are commonly thermally and chemically robust, while their physical properties such as the size, shape and chemical composition of the pores can be tailored towards selective adsorption of a wide range of guest molecules.² Chemical sensing by PCPs is an intriguing application that has been suggested, but remains much less extensively studied.^{3,4}

The PCM-15-based sensor of the present exhibits a measurable and reversible change that is induced by host-guest chemical interactions within the pores. PCM-15 is ideally suited for such an application, because sorption and desorption of guest adsorbates inside the pores is reversible over many cycles. In addition, the inherently high surface areas exhibited by PCM-15 s should allow for very small amounts of material to provide a sufficient sensor response in eventual devices.

From the standpoint of synthetic design, it is not trivial to prepare an efficient PCP sensor that can accurately identify the adsorbate(s) present. The vast majority of known PCP materials are constructed using metal cations and organic anions that form chemically-inert products, in which metal-ligand bonding interactions are maximized. Such materials therefore do not offer a convenient spectroscopic handle. Some of the more obvious routes by which PCP sensors might be prepared include: (i) incorporation of metal ions that show a measurable response to external stimulus (e.g. light,⁵ magnetism,⁶ temperature⁷); (ii) direct, or post-synthetic incorporation of guest-responsive organic moieties;⁸ and, (iii) exploitation of bulk guest-induced properties of PCP single crystals (e.g., vapochromism, mechanoluminescence).⁹ To date, route (i) has attracted the most significant attention, primarily because a number of metals that are photoluminescent can be directly incorporated into PCPs as the framework cations.^{10,11} Recent examples include those based on d-block metals such as Zn^{10a} and Cu,^{10b} and some Ln(III)-based materials.¹¹

Photoluminescence is known to be highly sensitive to the coordination environment of the metal ion.¹² However, in most reported examples of luminescent PCPs in which the metal sites are coordinated exclusively to organic ligand anions, the absorption and emission wavelengths and intensities do not vary to any significant degree as a function of guest species within the pores. This is to be expected, because vibrationally-coupled luminescence quenching is a short-range phenomenon that diminishes as a function of R⁻⁶ in the widely accepted Förster resonance electronic energy transfer model (R=donor-acceptor separation distance).¹³ So, in order to utilize relative luminescence in a PCP as a sensor to identify particular adsorbed species inside the pores, it is necessary to incorporate labile ligands. Removal of these ligands thus generates vacant coordination sites that allow guest molecules to interact much more closely with the luminescent metal sites, thus facilitating quantifiable luminescence quenching. Guest species with suitable donor groups (ROH, NR₃, etc.) may even directly coordinate to the vacant coordination sites.

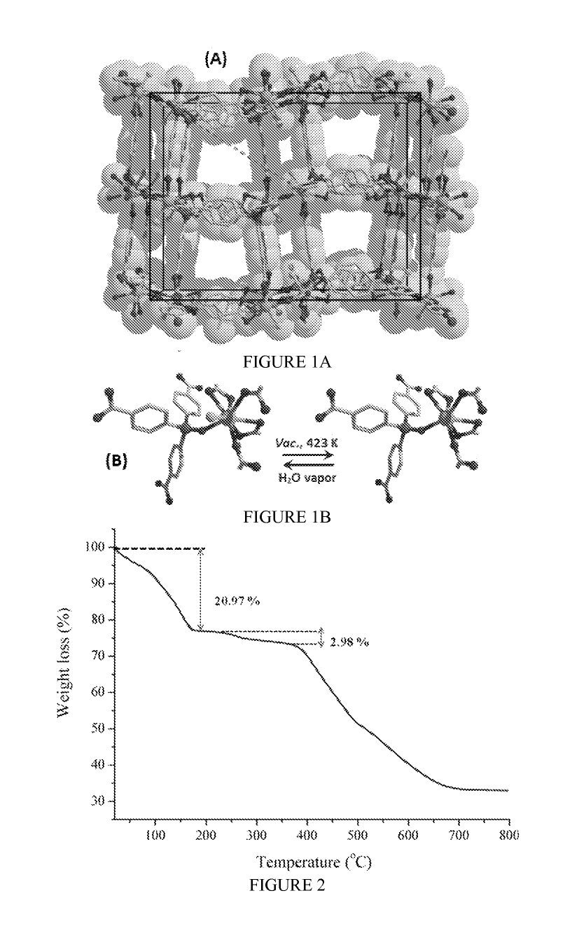

The present inventors recently reported a Tb(III)-based phosphine oxide coordination material, [Tb(tctpo)(OH₂)].₂dmf.H₂O (PCM-15; tctpo=P(═O)(C₆H₄—CO₂)₃), which is a highly robust three-dimensional coordination material with a two-dimensional (layered) pore network.¹⁴ The largest pore windows in PCM-15 measure 14.2 Å (diagonal distance Tb—P; FIG. 1A), rendering the interior of the material accessible to a broad range of small molecule adsorbates. As shown in FIG. 1B, each Tb(III) ion has a distorted square prismatic coordination sphere, in which six donors are supplied by phosphine oxide-based carboxylate groups and a seventh P═O moiety; the eighth coordination site is occupied by a terminal OH₂ ligand, which can be removed by heating at 423 K in vaccuo over 1 h, to obtain the ‘activated’ form of the material. Importantly, each OH₂ ligand projects into the pore, so the vacant coordination sites that are generated upon desolvation are readily accessible to guest adsorbates (FIG. 1B). Photoluminescence intensity of Tb(III) sites in PCM-15 was observed to undergo a reversible two-fold increase upon dehydration of the crystalline material, thus acting as an efficient and direct probe for the hydration state of metal sites in the polymer. The present invention provides detailed states for the activated material, and the luminescence quenching due to adsorption of fifteen different small molecule adsorbates. In addition, competition studies demonstrate the ability of PCM-15 to sense low-level impurities.

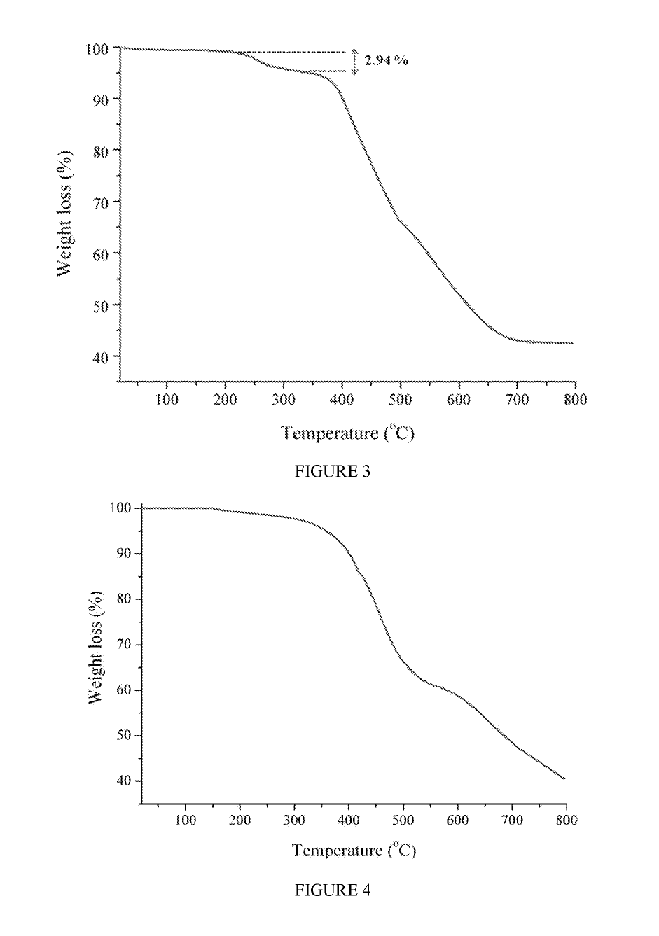

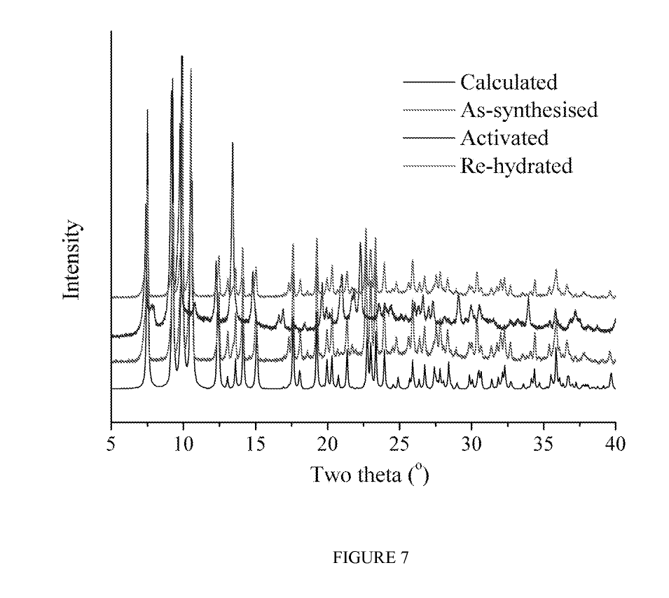

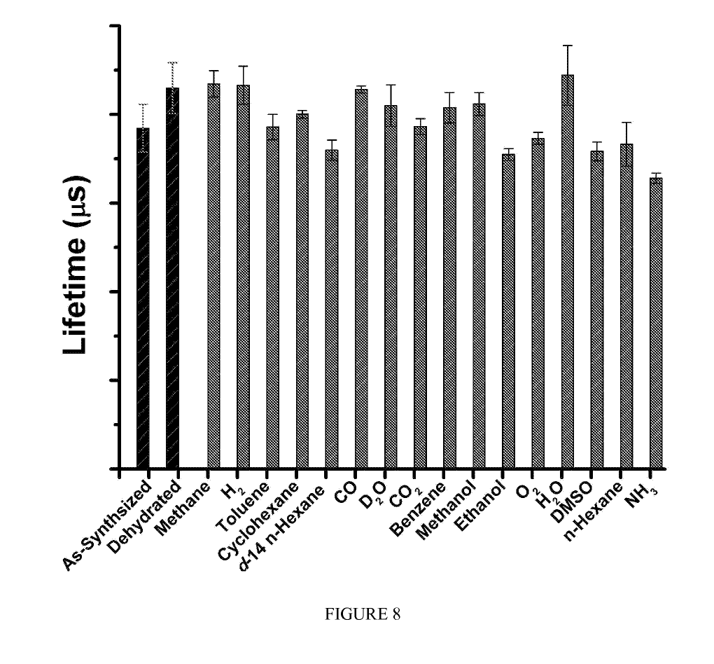

Crystalline samples of PCM-15 can be prepared in gram quantities by a low-temperature (358 K) reaction of Tb(NO₃)₂ and tctpoH₃ in DMF/THF/OH2 solvent.¹⁴ Thermogravimetric analyses (TGA; FIGS. 2-5) and corresponding bulk powder X-ray diffraction (PXRD; FIGS. 2 and 7) patterns of as-synthesized, desolvated and resolvated PCM-15 samples confirmed that the material retained its structural integrity throughout, including upon exposure to a range of gas and vapor adsorbates, and after subsequent reactivation in vaccuo. PCM-15 has a bulk surface area of 1187 m²g⁻¹ (BET method; CO₂).

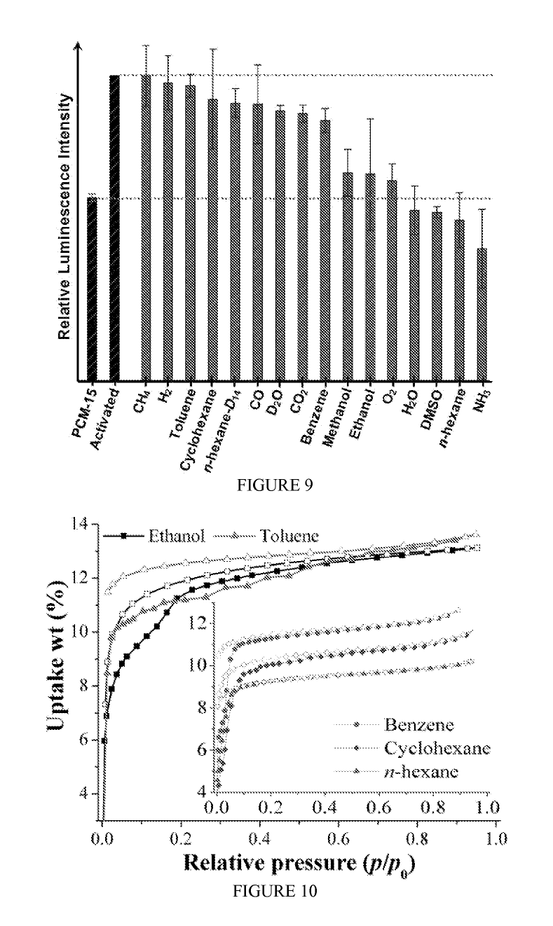

In order to accurately and reproducibly quantify the luminescence quantum yield and lifetime of the Tb(III) sites in PCM-15 in the presence of various guest adsorbates, a custom-made quartz cell with gas-tight Teflon valve was employed. The cell was designed to be directly interchangeable between the gas adsorption analyzer apparatus and the spectrophotometer cavity. This allowed each sample of PCM-15 to be activated under vacuum, then directly exposed to adsorbates in situ and studied spectrophotometrically over many cycles without physical manipulation or expose to the air. In each study, a freshly-synthesized batch of PCM-15 (30-50 mg) was activated as described above and the resulting in vacuuo luminescence quantum yield was measured to verify complete dehydration of the Tb(III) centers. The relative luminescence quantum yield approximately doubled in the activated (desolvated) form, due the absence of OH-vibrational quenching of the Tb(III) excited state.¹⁵ Next, activated samples were exposed to 1 atm of particular guest adsorbates for 30 min; in the case of gaseous adsorbates, the sample chamber was purged with ultra-high purity (UHP) gas; alternatively, anhydrous, degassed liquid adsorbates were vaporized with flowing UHP N₂ using an in-line bubbler. The resulting total luminescence quantum yields and lifetimes were then recorded for each of fifteen difference adsorbates; the data is summarized in FIGS. 8 & 9. Each measurement was repeated three or more times using freshly-prepared samples of PCM-15 to provide error ranges as shown (FIG. 9 & Table 1). It was possible to reactivate samples and recover the original luminescence behavior using the standard activation conditions for all of the adsorbates studied. The integrity of samples in the presence of various adsorbates was also monitored using PXRD (FIG. 6).

TABLE 1
Absolute values for relative luminescence intensities and corresponding
lifetimes as observed for guest-loaded PCM-15.

| | Relative | Lifetime |
|---|---|---|
| | Intensity | (μs) |
| Dehydrated | 1 | 860 ± 60 |
| As Synthesized | 0.60 ± 0.01 | 770 ± 50 |
| Methane | 1.0 ± 0.1 | 870 ± 30 |
| H2 | 0.98 ± 0.09 | 870 ± 40 |
| Toluene | 0.97 ± 0.04 | 770 ± 30 |
| Cyclohexane | 0.9 ± 0.2 | 801 ± 8 |
| d-14 n-Hexane | 0.91 ± 0.05 | 720 ± 20 |
| CO | 0.9 ± 0.1 | 856 ± 8 |
| D2O | 0.88 ± 0.02 | 820 ± 50 |
| CO2 | 0.88 ± 0.03 | 770 ± 20 |
| Benzene | 0.85 ± 0.04 | 820 ± 30 |
| Methanol | 0.68 ± 0.08 | 820 ± 30 |
| Ethanol | 0.7 ± 0.2 | 710 ± 10 |
| O2 | 0.66 ± 0.06 | 750 ± 10 |
| H2O | 0.56 ± 0.08 | 890 ± 70 |
| DMSO | 0.55 ± 0.02 | 720 ± 20 |
| n-Hexane | 0.53 ± 0.09 | 730 ± 50 |

Guest molecules that become adsorbed inside the pores of pre-activated PCM-15 could act as quenching agents, provided that: (i) they gain close proximity to the unsaturated Tb(III) centers in the pore walls (either via formal dative coordination to Tb, or more simply via favorable dipolar interactions within the pore); and, (ii) they can vibrationally-couple to the electronically excited state of the Tb(III) ions. In order to confirm this hypothesis, the luminescence quenching ability of a broad range of guest adsorbates were studied in PCM-15 (FIG. 9). Perhaps the most immediately striking trend is the large variation of total luminescence quenching that was observed, in which only three of the fifteen adsorbates studied caused more quenching than the fully solvated parent material (FIG. 6, blue dotted line).

H₂O itself is known to be a very effective quencher for Ln(III) luminescence. As an initial control study, an activated PCM-15 sample was exposed to an atmosphere of D₂O in N₂ gas. The resulting luminescence intensity was only found to be partially reduced since the vibrational frequency of O-D bonds are too low to facilitate efficient quenching of the excited Tb(III) ion (FIG. 9).¹⁵ Of the other fourteen adsorbates studied in this work, only NH₃, dimethylsulfoxide (DMSO) and n-hexane were found to be more effective quenching agents than H₂O itself. NH₃ was found to be the most effective guest quenching agent because it is chemically very similar to H₂O and should be able to directly occupy the Tb coordination sites within the pores. The absolute uptake of NH₃ by activated PCM-15 was confirmed by elemental analysis, which confirmed the presence of a single equivalent of NH₃ per Tb atom. DMSO is also a favorable ligand for Ln(III) ions via (H₃C)₂S═O—Tb coordination and the C—H bonds are vibrationally-matched to promote effective luminescence quenching.¹⁵

The observed quenching effect of n-hexane was more surprising since hydrocarbon solvents do not usually quench Ln(III) luminescence.¹⁶ Careful steps were followed in all instances to ensure that the adsorbate was rigorously pre-dried and to prevent exposure to ambient humidity; the adsorbates were also checked for purity prior to use by ¹HNMR and GC-MS. Sorption-desorption isotherms were collected for n-hexane in activated PCM-15 which revealed reversible type-I sorption behavior and a capacity of 10.2 wt % (p/p0=0.94) which corresponds to 0.67 n-hexane molecules per PCM-15 formula unit (FIG. 10, inset). The confirmation that n-hexane was indeed adsorbed into the pores of PCM-15 led us to believe that a quenching pathway was being observed, presumably via C—H vibrational modes of alkanes into close proximity of unsaturated Tb(III) sites. In support of this assumption, when perdeuterated d14-hexane was employed as the adsorbate, very minimal luminescence quenching was observed (FIG. 9).

Apolar adsorbates including CH₄, H₂, toluene and cyclohexane were not found to induce any significant quenching of the Tb(III) emission. CH₄ and H₂ adsorption isotherms for activated PCM-15 showed that both gases were indeed adsorbed inside the pores, with modest total uptakes at 1.0 bar.¹⁴ It was also possible to confirm that the significantly larger aromatic and aliphatic cyclic hydrocarbons were adsorbed inside PCM-15 (FIG. 10). The total uptake of both toluene and cyclohexane at 0.95 bar (0.83 and 0.79 molecules per formula unit, respectively) and the observation of significant hysteresis in the desorption step confirmed that these were preferentially adsorbed inside the pores of PCM-15. However, neither facilitated luminescence quenching. CO and CO₂ adsorption resulted in quenching that was intermediate between the hydrated and activated PCM-15 materials. In contrast, gaseous O₂ was a significantly more effective quencher, even though the relative total sorption capacities were similar.¹⁴

Finally, adsorption of methanol or ethanol into activated PCM-15 resulted in significant quenching, similar to that observed by H₂O. This is perhaps not surprising, as the alcohols should be able to form weakly dative ligand interactions to free sites on the Tb(III) centers, thus bringing O—H groups into close proximity. The adsorption-desorption profile of ethanol revealed a defined hysteresis that has been observed previously in similar PCP materials.¹⁷

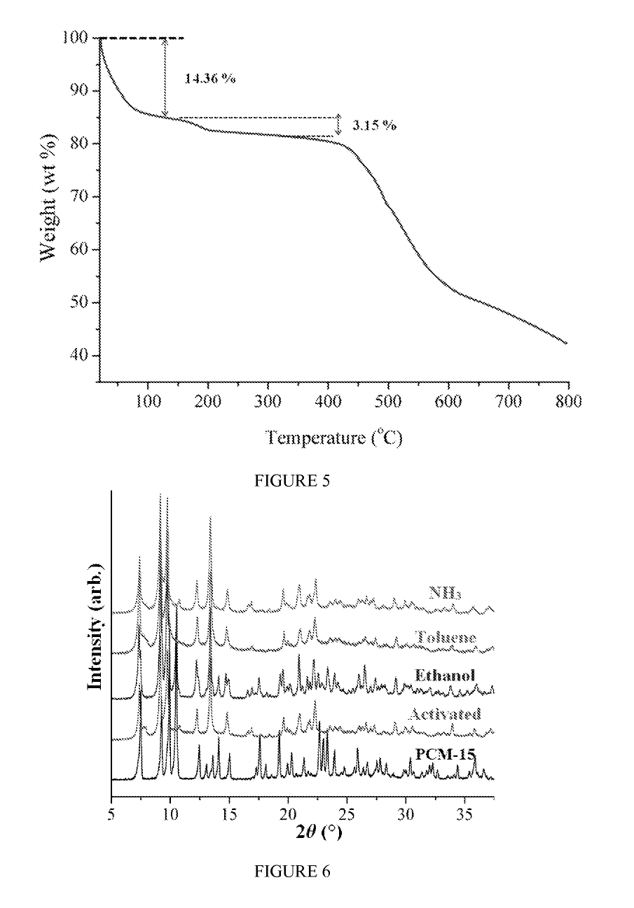

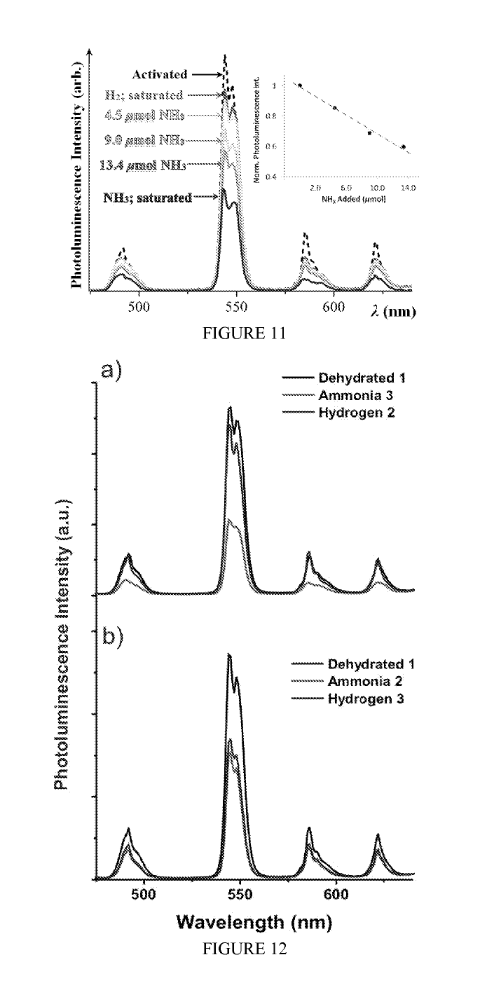

The potential application of PCM-15 as a sensor for the detection of small quantities of impurities was proven in a model study, in which trace amounts of a strong quencher (NH₃) were dosed into a non-quenching gas (H₂). A pre-activated sample was initially purged with H₂ gas at 298 K and the resulting photoluminescence intensity was recorded (FIG. 5, red line). Small aliquots of NH₃ (4.5 μmol) were then sequentially injected into the sample in situ and the relative change in luminescence intensity was recorded after each injection. As shown in FIG. 11, it was possible to detect a clear decrease in the luminescence intensity up to 13.4 μmol total added NH₃ (corresponding to 0.25 equivalents of NH₃ per Tb(III), thus still significantly below saturation). The calibration curve obtained by integration of normalized photoluminescence intensity versus amount of added NH₃ confirmed a linear response in the region NH₃/Tb≦0.25 (FIG. 11, inset; R=0.99 for fitted line). The preferential and irreversible binding of NH₃ in H₂-loaded PCM-15 was also confirmed by treating an NH3-loaded sample with H₂ gas, which did not result in NH₃ displacement (FIG. 12). This study illustrates that PCM-15 could be utilized to quantitatively detect low or trace levels of impurities in certain gas or vapor mixtures, in which the impurity is the strongest quenching agent.

In conclusion, the present inventors demonstrated that the Tb(III)-phosphine oxide coordination material PCM-15 can be used as an effective sensor for discrimination between a broad range of small molecule guest species, as determined by relative luminescence quenching of unsaturated Tb(III) sites. The measured luminescence quenching was shown to be directly proportional to amount of guest analyte within the pores. PCM-15 can also be used to quantitatively detect trace amounts of NH3 impurity in H₂ gas. Moreover, due to the high density of Tb(III) sensor sites within the polymer, the luminescence intensity of PCM-15 was easily detectable using only milligram quantities of sample. Therefore, PCM-15 could still function as an effective sensor when incorporated into devices in dilute form (e.g., impregnation into an inert matrix or membrane).

Materials and Measurements. 1,4-Dibromobenzene and PCl₃ (Aldrich), Tb(NO₃)₃.6H2O (Alfa Aesar) HCl and H₂O₂ (Fisher Scientific) were used as received. Tetrahydrofuran, N,N-dimethylformamide, diethyl ether, chloroform and dichloromethane (Fisher Scientific) were purified prior to use by degassing followed by column distillation on an Innovative Technologies Inc. PureSolv system, and stored on molecular sieves under dry N₂ prior to use. PCM-15 was synthesised by heating mixtures in 20 capped scintillation vials using graphite thermal baths, with the vials submerged below the internal solvent level. Infrared spectra were collected on crystalline analyte using a Nicolet Avatar 330 FT-IR spectrometer fitted with attenuated total reflectance apparatus. Thermogravimetric analysis (TGA) was performed under He atmosphere at a scan rate of 2° C. min⁻¹ in the range 25-800° C. using a TA instruments Q50 analyzer. NMR analyses ¹H and ³¹P were recorded in-house using a 300 MHz Oxford Instruments Cryomagnetic Systems spectrometer. Elemental analyses were performed by Intertek QTI, Whitehouse, N.J.

Photoluminescence Measurements. All spectroscopic data was obtained in the solid-state unless otherwise noted. Luminescent measurements were recorded on a Photon Technology International QM 4 spectrophotometer equipped with a 6-inch diameter K Sphere-B integrating sphere. For quantum yield measurements, the integrating sphere was used. Quantum yield was calculated by dividing the area under the emission peaks of the complex by the difference between the area under the excitation peak of the sample from that of a blank solution (Aem(sample)/(Aex(blank)−Aex(sample)), where A=area under peak).²⁰

PXRD Patterns. The phase purity of the PCM-15 samples was confirmed by analysis of powdered crystalline samples that were sealed inside borosilcate capillary tubes and spun in situ to prevent preferential orientation of the crystallites. Spectra were recorded on a Stoe Stadi-P diffractometer, operating in Debye-Scherrer geometry using CoKα radiation (1.790 Å). Reflection data was collected in the range 5.0-40.0° 2θ using multiple scans, which were subsequently averaged. The XRPD spectra were then compared directly to their corresponding simulated patterns that were generated in PLATON²¹ using hid reflection data obtained from the single crystal experiment.

Synthesis of trilithium salt of tris(p-carboxylato)triphenylphosphine ({P(C₆H₄-p-CO₂Li)₃}; tctpLi₃). This ligand was prepared using the reported method,¹⁸ which is a modified version of the original procedure reported by Amengual et al.¹⁹ that directly provides the trilithium salt. The salt was dried under vacuum to afford a pale yellow solid that was stored under N₂ (yield 68% based on the tris(p-bromo)triphenylphosphine intermediate). ¹H NMR (D₂O; 300 MHz): δ=7.38 (t, 6H); 7.70 ppm (dd, 6H); ³¹P NMR (D₂O; 162 MHz): δ=−6.66 ppm.

Synthesis of tris(p-carboxylic)triphenylphosphine oxide ({P(═O)(C₆H₄-p-CO₂H)₃}; tctpoH₃). TctpLi₃ (100 mg, 2.4 mmol) was dissolved into H₂O (10 mL) in a round-bottomed glass reactor tube fitted with magnetic stirred bar and heavy-duty Teflon-sealed screw cap. H₂O₂ (5 mL, 30%) was added and the mixture was vigorously stirred for 24 h. The resulting mixture was then cooled in an ice bath and acidified with ice cold HCl solution (1.0 M) to yield a white precipitate of potbcH3 that was isolated by vacuum filtration, washed with ether and dried under vacuum (yield: 614 mg, 63%). vmax (solid/cm⁻¹): 2929 w, 1699 m br, 1652 m, 1565 w, 1395 m, 1262 m br, 1161 m, 1103 s, 1017 m, 962 s, 933 s, 894 br s, 704 m; ¹H NMR (dmso; 300 MHz): δ=7.92 (d, 6H), 8.15 (d, 6H) ppm; ³¹P NMR (dmso; 300 MHz): δ=26 ppm.

Synthesis of PCM-15 ([Tb(tctpo)(OH2)].2dmf.H2O). TctpoH3 (20 mg, 48 μmol) and terbium nitrate (80 mg, 184 μmol) were mixed in dmf (3.0 mL), thf (4.0 mL), H2O (1.0 mL) and HCl (36.5%, 1 drop). The resultant slurry was stirred until complete dissolution occurred. The solution was then heated in a scintillation vial at 85° C. for 4 days (yield 23 mg, 64%). After treatment of as-synthesized PCM-15 in vacuum at 150° C. to remove solvent, found: C, 42.5; H, 2.28; N, 0.17%. C21H12O7PTb requires: C, 44.5; H, 2.14; N, 0%. vmax (solid/cm⁻¹): 3585 m, 3692 w, 2764 m, 2899 s, 2462 m, 2313 m, 1719 br m, 1465 w, 1387 s, 1256 m, 1166 s, 1059 s, 867 w, 756 m, 713 s.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context. In certain embodiments, the present invention may also include methods and compositions in which the transition phrase “consisting essentially of” or “consisting of” may also be used.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 8, 9, 10, 11, 12, 13, 14 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

Sculley, J.; Yuan, D.; Zhou, H. C. Energy Environ. Sci, 2012, 4, 2721-2735.

Li, J.-R.; Ma, Y.; McCarthy, M. C.; Sculley. J.; Yu, J.; Jeong, H.-K.; Balbuena, P. B., Zhou, H. C. Coordination Chemistry Reviews, 2011, 255, 1791-1823.

Allan, P. K., Wheatley, P. S.; Aldous, D.; Mohideen, M. I.; Tang, C.; Hriljac, J. A.; Megson, I. L.; Chapman, K. W.; Weireld, G. D.; Vaesen, S.; Morris, R. E. Dalton Trans., 2012, 41, 4060-4066.

Champness, N. R. Dalton Trans., 2011, 40, 10311-10315. (b) Yang, S.; Lin, X.; Lewis, W.; Suyetin, M.

Bichoutskaia, E.; Parker, J. E.; Tang, C. C.; Allan, D. R.; Rizkallah, P. J.; Huberstey, P.; Champness, N. R.; Thomas.

K. M.; Blake, A. J.; Schröder, M. Nat. Chem. 2012, 11, 710-716. (c) Liu, B. J. Mater. Chem., 2012, 22, 10094-10101.

Allendorf, M. D.; Bauer, C. A.; Bhakta, R. K.; Houk, R. J. T. Chem. Soc. Rev. 2009, 38, 1330-1352.

Cui, Y.; Yue, Y.; Qian, G.; Chen, B. Chem. Rev. 2012, 112, 1126-1162.

Zhao, Y.; Liu, X.; Yao, K. X.; Zhao, L.; Han, Y. Chem. Mater. 2012, 24, 4725-4734.

McDonald, T. M.; Lee, W. R.; Mason, J. A.; Hong, C. S.; Long, J. R. J. Am. Chem. Soc. 2012, 134, 7056-7065.

de Bettencourt-Dias, A.; Viswanathan, S.; Rollett, A. J. Am. Chem. Soc. 2007, 129, 15436-15437.

Lill, D. T.; de Bettencourt-Dias, A.; Cahill, C. L. Inorg. Chem. 2007, 46, 3960-3965.

Rocha, J.; Carlos, L. D.; Almeida Paz, F. A.; Ananias, D. Chem. Soc. Rev. 2011, 40, 926-940.

Kreno, L. E.; Leong, K.; Farha, O. K.; Allendorf, M., Van Duyne, R. P.; Hupp, J. T. Chem. Rev. 2012, 112, 1105-1125.

Esser, B.; Swager, T. M. Angew. Chem. Int. Ed. 2010, 49, 8872-8875.

Lefebvre, J.; Batchelor, R. J.; Leznoff, D. B. J. Am. Chem. Soc. 2004, 126, 16117-16125.

Lu, G.; Hupp, J. T. J. Am. Chem. Soc., 2010, 132, 7832-7833.

Liu, Z.-C.; Yang, Z.-Y.; Li, T.-R.; Wang, B.-D.; Li, Y.; Qin, D.-D.; Wang, M.-F.; Yan, M.-F. Dalton Trans., 2011, 40, 9370-9373.

Sava, D. F.; Rohwer, L. E. S.; Rodriguez, M. A.; Nenoff, T. M. J. Am. Chem. Soc. 2012, 134, 3983-3986.

An, J.; Shade, C. M.; Chengelis-Czegan, D. A.; Petoud, S.; Rosi, N. L. J. Am. Chem. Soc., 2011, 133, 1220-1223.

Rieter, W. J.; Taylor, K. M. L.; Lin, W. J. Am. Chem. Soc., 2007, 129, 9852-9853.

Valeur, B.; Brochon, J.-C., New Trends in Fluorescence Spectroscopy: Applications to Chemical and Life Science: Springer: New York, 2001.

Deniz, A. A.; Dahan, M.; Grunwell, J. R.; Ha, T.; Faulhaber, A. E.; Chemla, D. S.; Weiss, S.; Schultz, P. G. Proc. Natl. Acad. Sci. 1999, 96, 3670-3675.

Ibarra, I. A.; Hesterberg, T. W.; Holliday, B. J.; Lynch, V. M.; Humphrey, S. M. Dalton Trans. 2012, 41, 8003.

Ibarra, I. A.; Yoon, J. W.; Chang, J. S.; Lee, S. K.; Lynch, V. M.; Humphrey, S. M. Inorg. Chem. 2012, 51, 12242.

Sun, J.-K.; Yao, Q.-X.; Tian, Y.-Y.; Wu, L.; Zhu, G.-S.; Chen, R.-P.; Zhang, J. Chem. Eur. J. 2012, 18, 1924.

Choi, H. J.; Dined, M.; Long, J. R. J. Am. Chem. Soc. 2008, 130, 7848.

Humphrey, S. M.; Allan, P. K.; Oungoulian, S. E.; Ironside, M. S.; Wise, E. R. Dalton Trans. 2009, 2298.

Amengual, R.; Genin, F.; Michelet, V.; Savignac, M.; Genet, J.-P. Adv. Synth. Catal. 2002, 344, 393.

Aebischer, A.; Gumy, F.; Biinzli, J.-C. G. Phys. Chem. Chem. Phys., 2009, 11, 1346.

Spek, A. L. Platon, a Multipurpose Crystallographic Tool; Utrecht University: Utrecht, The Netherlands, 2009.

What is claimed is:

1. A composition comprising a terbium(III)-triphenylphosphine oxide coordinated polymer.

2. The composition of claim 1, wherein the polymer is formed as a layer on a substrate.

3. A method of making a composition comprising:
dissolving a tris(p-carboxylato)triphenylphosphine (P(C₆H₄-pCO₂Li)₃ in an aqueous solution in the presence of H₂O₂ under conditions to form a tris(p-carboxylic)triphenylphosphine oxide (P(═O)(C₆H₄-p-CO₂H)₃), precipitated by acidification and isolated by vacuum filtration;
mixing the tris(p-carboxylic)triphenylphosphine oxide (P(═O)(C₆H₄-p-CO₂H)₃) in the presence of terbium nitrate, dimethylformamide (DMF), tetrahydrofuran (THF), H₂O, and acid at 85° C.; and
isolating the Tb(tris(p-carboxylic)triphenylphosphine oxide)(OH2)].2DMF.H2O from the solvents under vacuum.

4. The method of claim 3, wherein the acid is HCl.

5. The method of claim 3, wherein the H₂O₂ is 30%.

6. A sensor comprising a terbium(III)-triphenylphosphine oxide coordination polymer surface deposited on a surface, wherein an analyte that interacts with the polymer layer luminesces in a distinct wavelength unique to each analyte.

7. A sensing device for detecting the presence of a chemical analyte, comprising:
a surface;
a continuous or discontinuous terbium(III)-triphenylphosphine oxide coordination polymer layer deposited on the surface, wherein the polymer layer is porous; and
a luminescence detector, wherein one or more analytes that interact with the polymer layer luminesce at distinct wavelengths unique to each analyte.

8. The sensing device of claim 7, wherein the terbium(III)-triphenylphosphine oxide coordination polymer layer comprises a metal organic framework.

9. The sensing device of claim 7, wherein the terbium(III)-triphenylphosphine oxide coordination polymer layer comprises any crystalline material comprised of organic and/or inorganic portions in a porous structure.

10. The sensing device of claim 7, wherein the analyte binding to the polymer layer is reversible and the sensor can be reused.

11. The sensing device of claim 7, wherein the sensor can be hydrated and dehydrated.

12. The sensing device of claim 7, wherein the polymer layer is formed by a process selected from at least one of chemical vapor deposition, physical vapor deposition, atomic layer deposition, and electrolytic deposition.

13. The sensing device of claim 7, further comprising a reference sensing device for providing a baseline reference, wherein the reference sensing device comprises a second surface without a terbium(III)-triphenylphosphine oxide coordination polymer layer.

14. The sensing device of claim 7, further comprising a plurality of sensing devices.

15. The sensing device of claim 7, wherein the sensing device senses molecular species selected at least one of water vapor, carbon dioxide, hydrogen, toluene, cyclohexane, n-hexane, carbon monoxide, carbon dioxide, benzene, methanol, ethanol, nitric oxide, nitrous oxide, oxygen, dimethylsulfoxide, and amines.

16. A method for detecting the presence of a chemical species, comprising the steps of:
providing a surface onto which a continuous or discontinuous terbium(III)-triphenylphosphine oxide coordination polymer layer deposited on the surface, wherein the polymer layer is porous;
contacting the polymer layer with one or more analytes; and
detecting luminescence at the polymer layer, wherein one or more analytes that interact with the polymer layer luminesce unique to each analyte.

17. The method of claim 16, wherein the terbium(III)-triphenylphosphine oxide coordination polymer layer comprises a metal organic framework.

18. The method of claim 16, wherein the terbium(III)-triphenylphosphine oxide coordination polymer layer comprises any crystalline material comprised of organic and/or inorganic portions in a porous structure.

19. The method of claim 16, wherein the analyte binding to the polymer layer is reversible and the sensor can be reused by applying a vacuum between exposure of the polymer layer to an analyte or analytes.

20. The method of claim 16, wherein the polymer layer is formed by a process selected from the list of processes selected from at least one of mechanical deposition, chemical vapor deposition, physical vapor deposition, atomic layer deposition, and electrolytic deposition.

21. The method of claim 16, further comprising a reference sensing device for providing a baseline reference, wherein the reference sensing device comprises a second surface without a terbium(III)-triphenylphosphine oxide coordination polymer layer.

22. The method of claim 16, further comprising a plurality of sensing devices.

23. The method of claim 16, wherein the sensing device senses molecular species selected from the list consisting of water vapor, carbon dioxide, methanol, ethanol, carbon monoxide, nitric oxide, nitrous oxide, organic amines, and organic compounds containing NO₂ groups.

24. The method of claim 16, in which the response of the sensor is controlled by the hydration state of the terbium(III)-triphenylphosphine oxide coordination polymer layer.

25. The method of claim 16, further comprising a plurality of sensing devices.

26. The method of claim 16, wherein the sensing device senses molecular species selected at least one of water vapor, carbon dioxide, hydrogen, toluene, cyclohexane, n-hexane, carbon monoxide, carbon dioxide, benzene, methanol, ethanol, nitric oxide, nitrous oxide, oxygen, dimethylsulfoxide, and amines.

27. The method of claim 16, wherein the luminescence is detected using a spectrophotometer.
